(19) United States
(12) Patent Application Publication
(10) Pub. No.: US 2013/0148945 A1
(43) Pub. Date: Jun. 13, 2013

(54) METHOD FOR PERFORMING SCHEDULE CONTROL OF A MULTICHANNEL BROADCASTING PROGRAM RECEIVER, AND ASSOCIATED APPARATUS

(71) Applicants: Yuankang Li, Hefei (CN); Shanqi Tao, Hefei (CN); Jian-Hua Lin, MaoMing city (CN)

(72) Inventors: Yuankang Li, Hefei (CN); Shanqi Tao, Hefei (CN); Jian-Hua Lin, MaoMing city (CN)

(21) Appl. No.: 13/517,048

(22) PCT Filed: Dec. 13, 2011
(86) PCT No.: PCT/CN2011/083870

§ 371 Date: Jun. 18, 2012

(51) Int. Cl. H04N 5/76

(52) U.S. Cl. 386/296; 386/E05.001

(57) ABSTRACT

A method for performing schedule control of a multichannel broadcasting program receiver includes: retrieving viewing plan information from outside the multichannel broadcasting program receiver, for use of determining a program viewing plan for a user, wherein the viewing plan information indicates at least one source viewing plan recommended by at least one other user/service provider; and when it is detected that a current time matches a start time of a specific program indicated by the program viewing plan, triggering the multichannel broadcasting program receiver to turn on a main power of the multichannel broadcasting program receiver, allowing the specific program to be watched/recorded. An associated apparatus is also provided. For example, the apparatus may include a portion of the multichannel broadcasting program receiver, such as a control circuit of the multichannel broadcasting program receiver. In another example, the apparatus may include the whole of the multichannel broadcasting program receiver.

### BACKGROUND OF THE INVENTION

1. Field of the Invention

The present invention relates to schedule control of an audio/video reproducing system, and more particularly, to a method for performing schedule control of a multichannel broadcasting program receiver, and to an associated apparatus.

2. Description of the Related Art

Multichannel broadcasting program systems such as televisions (TVs) or TV receivers may be very important to those who enjoy watching TV programs with their family or close friends. In a situation where somebody of them can no longer be with his/her family or close friends due to some reasons such as job/career considerations, he/she may experience a pang of sadness when watching a certain meaningful program alone in front of the TV (e.g. in a big and crowded city far from his/her hometown). Thus, a novel method is required for providing such a user, who is experiencing sadness in the same or similar situation, with some facilities allowing him/her to experience the pleasure of viewing the same program at the same time with his/her family or close friends as if they were in the same living room.

### BRIEF SUMMARY OF THE INVENTION

It is therefore an objective of the claimed invention to provide a method for performing schedule control of a multichannel broadcasting program receiver, and to provide an associated apparatus, in order to automatically control power on/off and channel switching of a multichannel broadcasting program receiver for a user.

It is another objective of the claimed invention to provide a method for performing schedule control of a multichannel broadcasting program receiver, and to provide an associated apparatus, in order to provide a user with some facilities allowing him/her to experience the pleasure of viewing the same program at the same time with his/her family or close friends as if they were in the same living room.

It is another objective of the claimed invention to provide a method for performing schedule control of a multichannel broadcasting program receiver, and to provide an associated apparatus, in order to save power through schedule control. As a result of applying the method, unnecessary power consumption can be prevented.

An exemplary embodiment of a method for performing schedule control of a multichannel broadcasting program receiver comprises: retrieving viewing plan information from outside the multichannel broadcasting program receiver, for use of determining a program viewing plan for a user, wherein the viewing plan information indicates at least one source viewing plan recommended by at least one other user/service provider; and when it is detected that a current time matches a start time of a specific program indicated by the program viewing plan, triggering the multichannel broadcasting program receiver to turn on a main power of the multichannel broadcasting program receiver, allowing the specific program to be watched/recorded. In particular, the step of triggering the multichannel broadcasting program receiver to turn on the main power of the multichannel broadcasting program receiver further comprises: when it is detected that the current time matches the start time of the specific program indicated by the program viewing plan, triggering the multichannel broadcasting program receiver to turn on the main power and switch to a specific channel corresponding to the specific program, allowing the specific program to be watched/recorded, wherein the program viewing plan indicates that the specific program is broadcasted on the specific channel.

An exemplary embodiment of an associated apparatus for performing schedule control of a multichannel broadcasting program receiver comprises a control circuit arranged to control operations of the multichannel broadcasting program receiver, wherein the processing circuit comprises a processing module and a time control module. The processing module is arranged to retrieve viewing plan information from outside the multichannel broadcasting program receiver, for use of determining a program viewing plan for a user, wherein the viewing plan information indicates at least one source viewing plan recommended by at least one other user/service provider. In addition, when it is detected that a current time matches a start time of a specific program indicated by the program viewing plan, the time control module triggers the multichannel broadcasting program receiver to turn on a main power of the multichannel broadcasting program receiver, allowing the specific program to be watched/recorded.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1A is a diagram of an apparatus for performing schedule control of a multichannel broadcasting program receiver according to a first embodiment of the present invention.

FIGS. 1B-1C respectively illustrate some implementation details involved with the apparatus shown in FIG. 1A according to different embodiments of the present invention.

FIG. 1D illustrates some exemplary sources of viewing plan information utilized by the apparatus shown in FIG. 1A according to an embodiment of the present invention.

FIG. 2 is a flowchart of a method for performing schedule control of a multichannel broadcasting program receiver according to an embodiment of the present invention.

FIG. 3 illustrates a working flow involved with the method shown in FIG. 2 according to an embodiment of the present invention.

FIGS. 4A-4B illustrate a working flow involved with the method shown in FIG. 2 according to another embodiment of the present invention.

FIG. 5 is a diagram of an apparatus for performing schedule control of a multichannel broadcasting program receiver according to a second embodiment of the present invention.

### DETAILED DESCRIPTION OF THE INVENTION

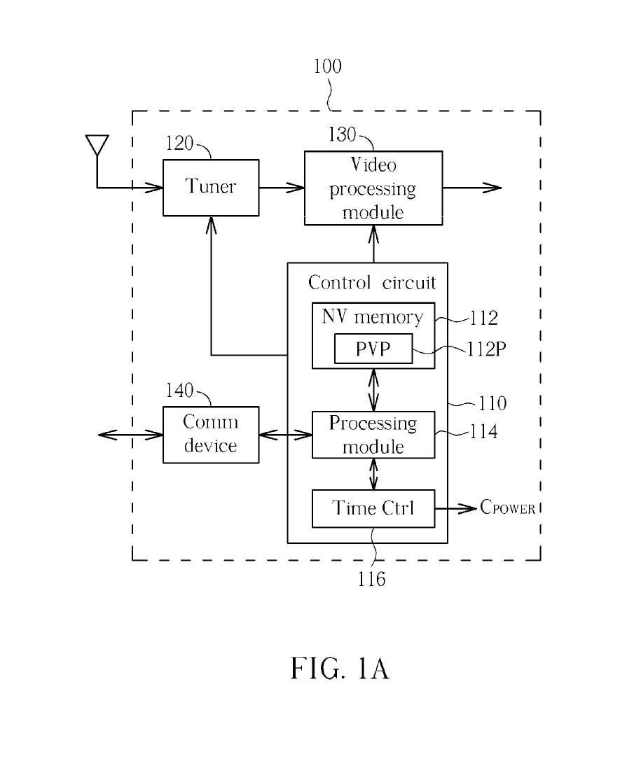

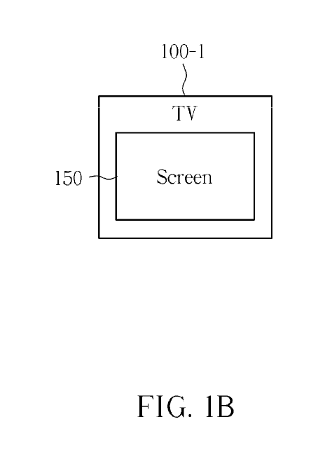

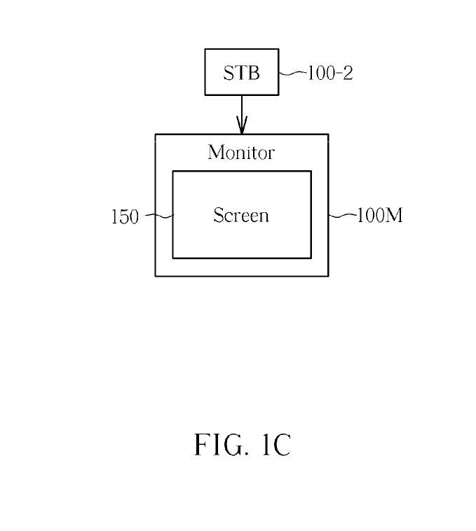

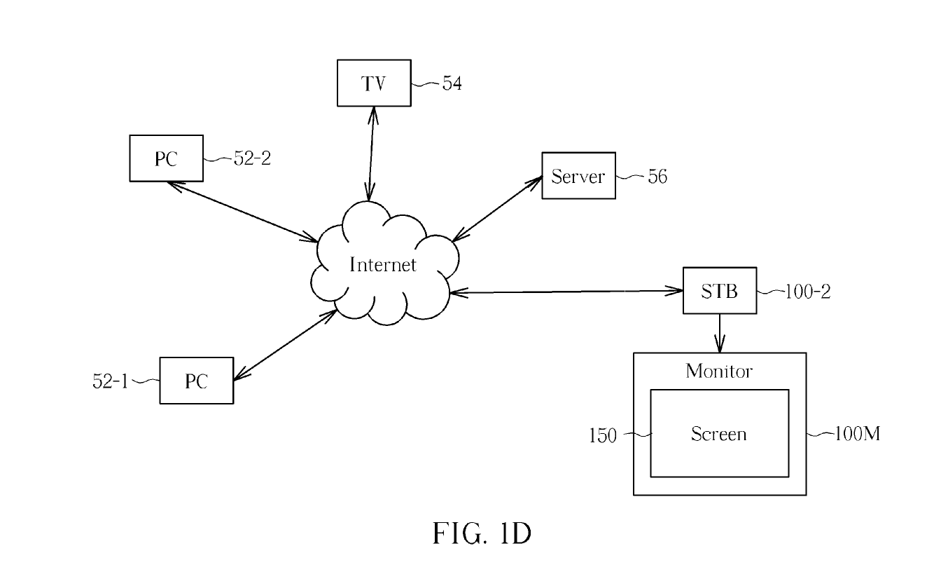

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections. Please refer to FIG. 1A, which illustrates a diagram of an apparatus 100 for performing schedule control (e.g. schedule control regarding power on/off and/or channel switching) of a multichannel broadcasting program receiver according to a first embodiment of the present invention. The apparatus 100 comprises a control circuit 110 arranged to control operations of the multichannel broadcasting program receiver, where the control circuit 110 comprises a non-volatile memory 112 (labeled “NV memory” in FIG. 1A) such as a Flash memory or an Electrically Erasable Programmable Read Only Memory (EEPROM), and further comprises a processing module 114 and a time control module 116 (labeled “Time Ctrl” in FIG. 1A). For example, the time control module 116 can be implemented by utilizing a hardware circuit comprising a real time clock (RTC). In particular, the apparatus 100 of this embodiment may further comprise a tuner 120, a video processing module 130, and at least one communication device 140 (labeled “Comm device” in FIG. 1A). The tuner 120 is arranged to select one of a plurality of channels, and the video processing module 130 is arranged to perform video processing, while the communication device 140 can be utilized for performing communication operations, and more particularly, for accessing information from outside the multichannel broadcasting program receiver. For example, the tuner 120 can be a digital tuner and the video processing module 130 can be a digital processing module implemented with digital signal processing (DSP) technology. In another example, the tuner 120 can be an analog tuner and the video processing module 130 can be a signal processing module.

According to a special case of this embodiment, in a situation where the tuner 120 is a digital tuner, the video processing module 130 can be a video processing circuit comprising a Moving Picture Experts Group (MPEG) demultiplexer, an MPEG video decoder, and an image processor (which are not shown in FIG. 1A, for brevity). The MPEG demultiplexer is arranged to demultiplex video content and audio content of a program on the channel selected by the tuner 120 such as the digital tuner. In addition, the MPEG video decoder is arranged to decode the video content demultiplexed by the MPEG demultiplexer, and more particularly, to perform MPEG-decoding on the video content. Additionally, the image processor may further perform image processing on the decoded video content to be displayed. Please note that whether an on screen display (OSD) processing circuit is utilized for processing the video content to be displayed depends on different variations of this embodiment. In addition, according to different variations of this embodiment, a display module can be integrated into the apparatus 100.

According to the embodiment shown in FIG. 1A, the non-volatile memory 112 is arranged to store a program viewing plan 112P (labeled “PVP” in FIG. 1A) for a user, where the program viewing plan 112P can also be referred to as the program watching plan. More particularly, the processing module 114 is arranged to retrieve viewing plan information from outside the multichannel broadcasting program receiver, for use of determining the program viewing plan 112P for the user, where the viewing plan information indicates at least one source viewing plan recommended by at least one other user/service provider. The viewing plan information may selectively be altered (or edited) by the user through the user interface of the apparatus 100. For example, the user interface may comprise one or more buttons implemented on a remote controller, or comprise one or more virtual buttons implemented on a touch screen. No matter whether the program viewing plan 112P is determined fully based upon the viewing plan information or is determined partially based upon the viewing plan information, the program viewing plan 112P can be eventually stored in the non-volatile memory 112. In addition, when it is detected that a current time matches a start time of a specific program indicated by the program viewing plan 112P, the time control module 116 triggers the multichannel broadcasting program receiver to turn on a main power of the multichannel broadcasting program receiver through a power control signal C_{POWER}, allowing the specific program to be watched/recorded.

Please note that the implementation of the apparatus 100 may vary according to different embodiments, such as the embodiment shown in FIG. 1A or some variations thereof. For example, the apparatus 100 may comprise at least one portion (e.g. a portion or all) of the multichannel broadcasting program receiver. In a situation where the apparatus 100 comprises a portion of the multichannel broadcasting program receiver, the control circuit 110 can be the control circuit of the multichannel broadcasting program receiver, such as an integrated circuit (IC). In a situation where the apparatus 100 comprises the whole of the multichannel broadcasting program receiver, the apparatus 100 can be the multichannel broadcasting program receiver, or can be an audio/video reproducing system comprising the multichannel broadcasting program receiver.

In some embodiments, such as the embodiment shown in FIG. 1A or some variations thereof, the multichannel broadcasting program receiver mentioned above can be one of a digital video recorder (DVR) (which can be equipped with program receiving functionality, for example), a set top box (STB), a television (TV), and a TV receiver, or can be a combination of a DVR, an STB, a TV, and/or a TV receiver. According to one of these embodiments, such as that shown in FIG. 1B, the multichannel broadcasting program receiver can be a TV 100-1 comprising a screen 150 (e.g. a liquid crystal display (LCD) panel) for displaying images of the program, where the apparatus 100 may comprise at least one portion (e.g. a portion or all) of the TV 100-1. According to another of these embodiments, such as that shown in FIG. 1C, the multichannel broadcasting program receiver can be an STB 100-2, and is capable of controlling the power on/off status of the monitor 100M comprising the screen 150 (e.g. an LCD panel), which is utilized for displaying images of the program, and more particularly, the images carried by at least one signal sent from the STB 100-2, where the apparatus 100 may comprise at least one portion (e.g. a portion or all) of the STB 100-2.

FIG. 1D illustrates some exemplary sources of the aforementioned viewing plan information utilized by the apparatus 100 shown in FIG. 1A according to an embodiment of the present invention. For better comprehension, the STB 100-2 shown in FIG. 1C is taken as an example of the multichannel broadcasting program receiver of this embodiment. This is for illustrative purposes only, and is not meant to be a limitation of the present invention. According to some variations of this embodiment, other kinds of electronic devices (e.g. the TV 100-1 shown in FIG. 1B) can be taken as examples of the multichannel broadcasting program receiver of these variations.

As shown in FIG. 1D, the user may utilize the apparatus 100 to retrieve the aforementioned viewing plan information through Internet. For example, another user may utilize a personal computer (PC) 52-1 to provide his/her own viewing plan on a certain web page, and a service provider such as a person may utilize another PC 52-2 to provide his/her own viewing plan on the same web page or another web page. In addition, another user may utilize a TV 54 to provide his/her own viewing plan on the same web page or another web page. Additionally, another service provider such as a company may utilize a server 56 to provide one or more viewing plans on the same web page or another web page. Thus, the apparatus 100 can utilize these viewing plans recommended by the other users/service providers as source viewing plans, and utilize information of at least one portion (e.g. a portion or all) of the source viewing plans as the aforementioned viewing plan information, for use of determining the program viewing plan 112P.

For example, in a situation where the user prefers a specific source viewing plan of these source viewing plans, by utilizing the user interface of the apparatus 100, he/she may select to directly utilize the specific source viewing plan, and therefore, the apparatus 100 utilizes the information of the specific source viewing plan as the aforementioned viewing plan information to configure the program viewing plan 112P. In another example, in a situation where the user is not satisfied with any of these source viewing plans, by utilizing the user interface of the apparatus 100, he/she may select to utilize an altered version of a specific source viewing plan of these source viewing plans, and therefore, the apparatus 100 retrieves and alters the information of the specific source viewing plan in response to user selection or user control, and utilizes the altered information as the aforementioned viewing plan information to configure the program viewing plan 112P. As a result, the multichannel broadcasting program receiver may operate automatically, and the user may watch (or record) programs on schedule, having no need to spend a lot of time on scheduling. In addition, in a situation where the user is touring/living without being accompanied by his/her family or close friends, the program viewing plan 112P can be determined based on the viewing plan information of a source viewing plan recommended by another user such as a family member or a close friend, and they may experience the pleasure of viewing the same program at the same time as if they were in the same living room.

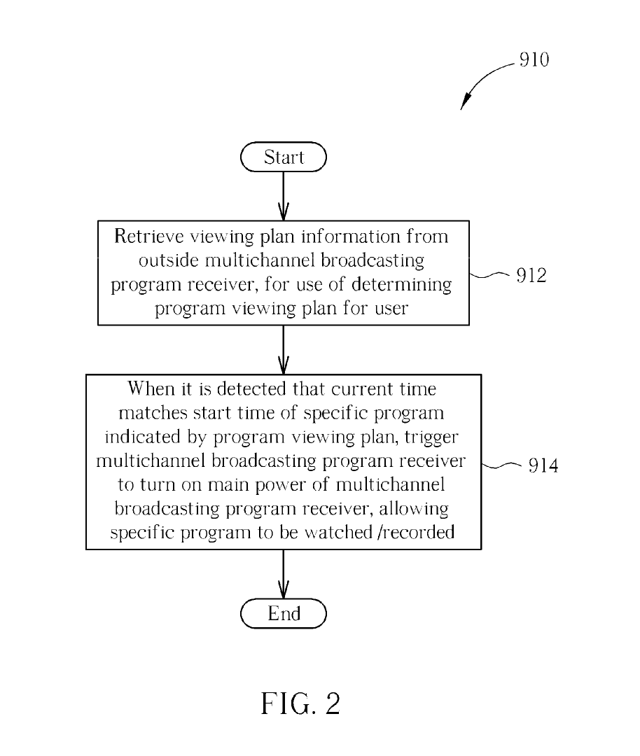

FIG. 2 is a flowchart of a method 910 for performing schedule control (e.g. schedule control regarding power on/off and/or channel switching) of a multichannel broadcasting program receiver according to an embodiment of the present invention. The method 910 shown in FIG. 2 can be applied to the apparatus 100 of any of the embodiment shown in FIG. 1A and the variations thereof. The method is described as follows.

In Step 912, the processing module 114 retrieves the viewing plan information from outside the multichannel broadcasting program receiver, for use of determining the program viewing plan 112P for the user, where the viewing plan information indicates at least one source viewing plan recommended by at least one other user/service provider (e.g. one or more source viewing plans recommended by at least one other user such as one or more other users, or one or more source viewing plans recommended by at least one service provider such as one or more service providers). More particularly, the processing module 114 can retrieve the viewing plan information from outside the multichannel broadcasting program receiver by utilizing at least one communication device, such as the aforementioned at least one communication device 140. For example, the aforementioned at least one communication device 140 may comprise an optical communication device such as an infrared (IR) communication device. In another example, the aforementioned at least one communication device 140 may comprise a wireless communication device, such as a Bluetooth (BT) communication device or an IEEE 802.11 g communication device (e.g. a Wireless Fidelity (Wi-Fi) communication device). According to this embodiment, the user may utilize a PC (e.g. a laptop computer or a desktop computer) to retrieve the viewing plan information from a web page (or a server) through Internet in advance, and the processing module 114 can utilize the communication device 140 to retrieve the viewing plan information from the PC. In practice, the viewing plan information may comply with a predetermined format corresponding to a set of rules for encoding documents in a machine-readable form. For example, the predetermined format can be an Extensible Markup Language (XML) format. In another example, the predetermined format can be a Really Simple Syndication (RSS) format. This is for illustrative purposes only, and is not meant to be a limitation of the present invention. According to some variations of this embodiment, in a situation where the communication device 140 comprises a wired or wireless network communication device, the communication device 140 can retrieve the viewing plan information from outside the multichannel broadcasting program receiver through Internet, and more particularly, can retrieve the viewing plan information from the aforementioned web page (or the aforementioned server) through Internet. For example, the predetermined format can be the aforementioned XML format, and the apparatus 100 can retrieve the viewing plan information through Internet under control of the user. In another example, the predetermined format can be the aforementioned RSS format, and the apparatus 100 can retrieve the viewing plan information through Internet automatically.

In Step 914, when it is detected that the current time matches the start time of the specific program indicated by the program viewing plan 112P, the time control module 116 triggers the multichannel broadcasting program receiver to turn on the main power of the multichannel broadcasting program receiver, allowing the specific program to be watched/recorded. More particularly, when it is detected that the current time matches the start time of the specific program indicated by the program viewing plan 112P, the time control module 116 triggers the multichannel broadcasting program receiver to turn on the main power and switch to a specific channel CH(0) corresponding to the specific program, allowing the specific program to be watched/recorded. As the program viewing plan 112P may indicate that the specific program is broadcasted on the specific channel CH(0), the processing module 114 can control the tuner 120 to switch to the specific channel CH(0) after the main power is turned on. In practice, based upon the program viewing plan 112P, the processing module 114 can configure the turn on time for the time control module 116 in advance, in order to make the time control module 116 automatically trigger the multichannel broadcasting program receiver to accurately turn on the main power at the aforementioned start time of the specific program.

In practice, when it is detected that the current time matches the start time of the specific program indicated by the program viewing plan 112P, the control circuit 110 may send at least one signal to trigger at least one display/recording device (one or more display devices, or one or more recording devices) to be turned on, allowing the specific program to be watched/recorded. For example, the aforementioned at least one display/recording device is outside the multichannel broadcasting program receiver, and the aforementioned at least one signal may comprise at least one remote control signal, where the display/recording device can be automatically turned on under control of the remote control signal. In another example, the aforementioned at least one display/recording device is outside the multichannel broadcasting program receiver, and the aforementioned at least one signal may comprise at least one video signal, where the display/recording device can be automatically turned on in response to the appearance of the video signal. In another example, the aforementioned at least one display/recording device is within the multichannel broadcasting program receiver, and the aforementioned at least one signal may comprise at least one enabling/disabling signal.

Please note that, according to this embodiment or some variations thereof, the display device can be an LCD panel or a plasma display panel (PDP) in a situation where the display device is within the multichannel broadcasting program receiver, or can be a monitor comprising an LCD panel or a PDP in a situation where the display device is outside the multichannel broadcasting program receiver. In addition, according to this embodiment or some variations thereof, the recording device can be a hard disk drive (HDD) or a Flash memory in a situation where the recording device is within the multichannel broadcasting program receiver, or can be an external HDD or a Universal Serial Bus (USB) disk (which may comprise a Flash memory) in a situation where the recording device is outside the multichannel broadcasting program receiver.

According to the embodiment shown in FIG. 2, as the apparatus 100 can automatically turn on the main power in response to the time control of the time control module 116 based upon the program viewing plan 112P, the multichannel broadcasting program receiver can be arranged to stay in a standby status by default. As a result of applying the method, the apparatus 100 can save power by preventing unnecessary power consumption, and can automatically control the schedule of watching/recording programs for the user. For example, referring to FIG. 1B, the schedule control of the TV 100-1 can be properly performed based upon the program viewing plan 112P, while unnecessary power consumption of the TV 100-1 can be prevented. In another example, referring to FIG. 1C, the schedule control of the STB 100-2 can be properly performed based upon the program viewing plan 112P, while unnecessary power consumption of both the STB 100-2 and the monitor 100M can be prevented.

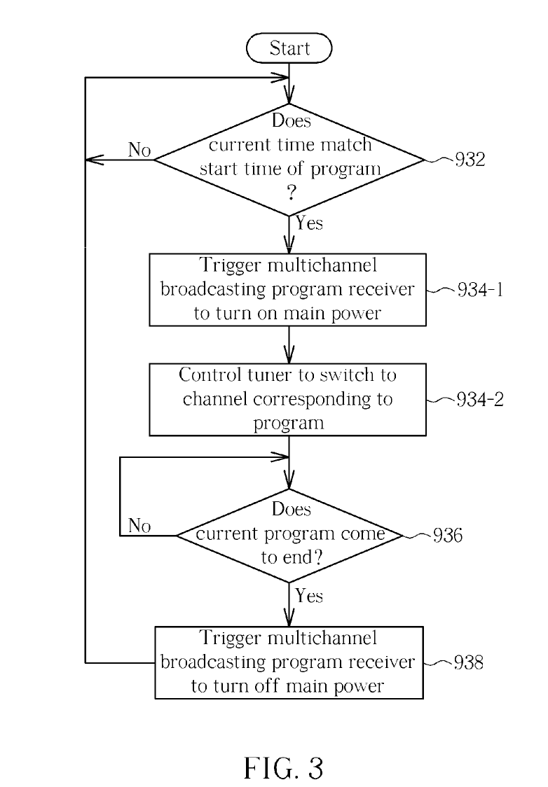

FIG. 3 illustrates a working flow involved with the method 910 shown in FIG. 2 according to an embodiment of the present invention.

In Step 932, the time control module 116 checks whether the current time matches the start time of a program such as the aforementioned specific program indicated by the program viewing plan 112P. When it is detected that the current time matches the start time of the program such as the specific program, Step 934-1 is entered; otherwise, Step 932 is re-entered.

In Step 934-1, the time control module 116 triggers the multichannel broadcasting program receiver to turn on the main power.

In Step 934-2, the processing module 114 controls the tuner 120 to switch to the channel corresponding to the program (i.e. the program mentioned in Step 932), such as the specific channel CH(0).

In Step 936, the processing module 114 checks whether the current program such as the specific program comes to an end. For example, the processing module 114 determines whether the specific program comes to the end by detecting whether it is an end time of the specific program. In another example, the processing module 114 determines whether the specific program comes to the end by detecting whether a predetermined duration of the specific program is expired. When it is detected that the current program such as the specific program comes to the end, Step 938 is entered; otherwise, Step 936 is re-entered.

In Step 938, the processing module 114 triggers the multichannel broadcasting program receiver to turn off the main power. For example, in a situation where no program should take its turn to be watched/recorded at this moment, the processing module 114 can trigger the multichannel broadcasting program receiver to turn off the main power at once, and therefore, after Step 938 is executed, Step 932 is re-entered. This is for illustrative purposes only, and is not meant to be a limitation of the present invention. According to some variations of this embodiment, in a situation where another program should take its turn to be watched/recorded at this moment, the processing module 114 will not trigger the multichannel broadcasting program receiver to turn off the main power at once, and therefore, the working flow shown in FIGS. 3 and some associated steps therein should be altered in these variations.

Thus, according to this embodiment or some variations thereof, after triggering the multichannel broadcasting program receiver (e.g. the multichannel broadcasting program receiver mentioned in Step 914) to turn on the main power, when it is detected that the specific program comes to the end, the processing module 114 can trigger the multichannel broadcasting program receiver to turn off the main power in a situation where no program should take its turn to be watched/recorded at once.

In practice, based upon the program viewing plan 112P, the processing module 114 can determine whether any program should take its turn to be watched/recorded in advance, in order to properly control the operations of the apparatus 100. In addition, based upon the program viewing plan 112P, the processing module 114 can determine, in advance, whether another program should take its turn to be watched/recorded just after the current program being watched/recorded (e.g. the program mentioned in Step 932) comes to the end. Additionally, based upon the program viewing plan 112P, the processing module 114 can also determine, in advance, whether another program should take its turn to be watched/recorded before the current program being watched/recorded (e.g. the program mentioned in Step 932) comes to the end.

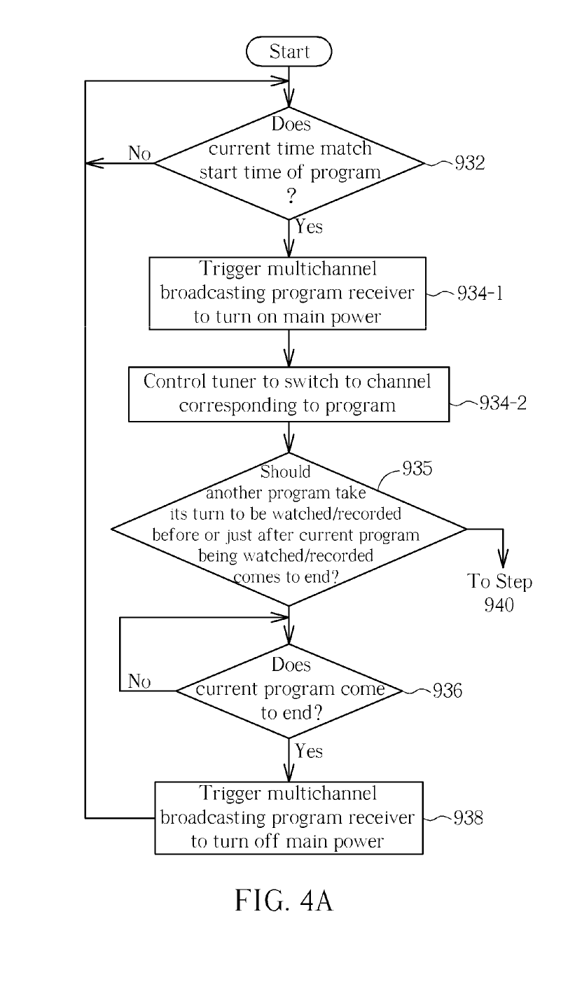

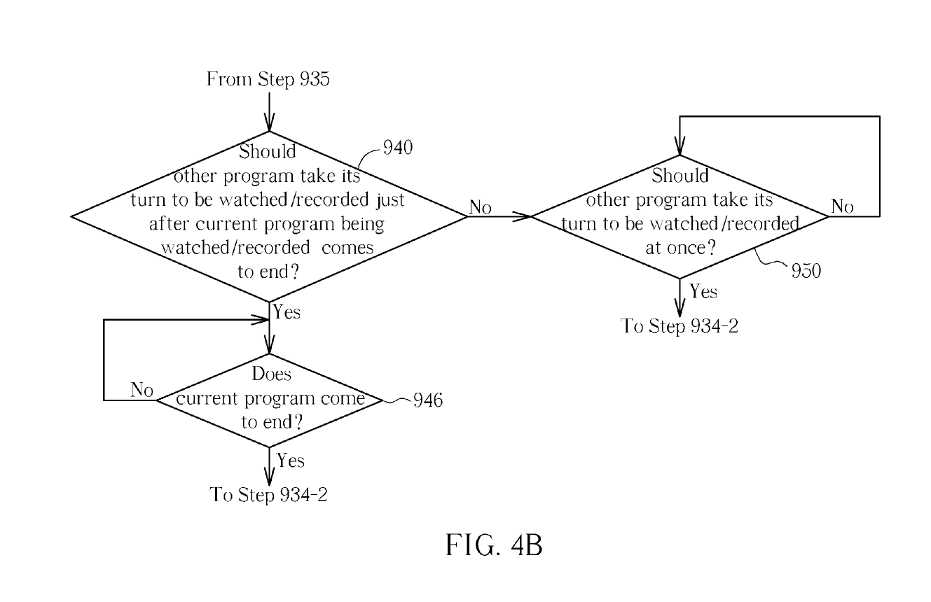

FIGS. 4A-4B illustrate a working flow involved with the method 910 shown in FIG. 2 according to another embodiment of the present invention.

Referring to FIG. 4A, in Step 932, the time control module 116 checks whether the current time matches the start time of a program such as the aforementioned specific program indicated by the program viewing plan 112P. When it is detected that the current time matches the start time of the program such as the specific program, Step 934-1 is entered; otherwise, Step 932 is re-entered.

In Step 934-1, the time control module 116 triggers the multichannel broadcasting program receiver to turn on the main power.

In Step 934-2, the processing module 114 controls the tuner 120 to switch to the channel corresponding to the program (i.e. the program mentioned in Step 932). For example, after the latest power on caused by executing Step 934-1, the processing module 114 may control the tuner 120 to switch to the specific channel CH(0) corresponding to the specific program mentioned above.

In Step 935, the processing module 114 checks whether another program (e.g. the next program, if exists) should take its turn to be watched/recorded before or just after the current program being watched/recorded (e.g. the program mentioned in Step 932) comes to an end. When it is detected that the other program (i.e. the aforementioned “another program” in this step, such as the next program mentioned above) should take its turn to be watched/recorded before or just after the current program being watched/recorded comes to the end, Step 940 is entered; otherwise, Step 936 is entered.

In Step 936, the processing module 114 checks whether the current program such as the specific program comes to the end. For example, the processing module 114 determines whether the specific program comes to the end by detecting whether it is the end time of the specific program. In another example, the processing module 114 determines whether the specific program comes to the end by detecting whether the predetermined duration of the specific program is expired. When it is detected that the current program such as the specific program comes to the end, Step 938 is entered; otherwise, Step 936 is re-entered.

In Step 938, the processing module 114 triggers the multichannel broadcasting program receiver to turn off the main power. After Step 938 is executed, Step 932 is re-entered, with the other program (i.e. the aforementioned “another program” in Step 935, such as the next program mentioned above) playing the role of the program mentioned in Step 932.

Referring to FIG. 4B, in Step 940, the processing module 114 checks whether the other program (i.e. the aforementioned “another program” in Step 935, such as the next program mentioned above) should take its turn to be watched/recorded just after the current program being watched/recorded (e.g. the program mentioned in Step 932) comes to the end. When it is detected that the other program should take its turn to be watched/recorded just after the current program being watched/recorded comes to the end, Step 946 is entered; otherwise (which means the other program should take its turn to be watched/recorded before the current program being watched/recorded comes to the end), Step 950 is entered.

In Step 946, the processing module 114 checks whether the current program such as the specific program comes to the end. For example, the processing module 114 determines whether the specific program comes to the end by detecting whether it is the end time of the specific program. In another example, the processing module 114 determines whether the specific program comes to the end by detecting whether the predetermined duration of the specific program is expired. When it is detected that the current program such as the specific program comes to the end, Step 934-2 is re-entered, with the other program (i.e. the aforementioned “another program” in Step 935, such as the next program mentioned above) playing the role of the program mentioned in Step 934-2; otherwise, Step 946 is re-entered.

In Step 950, the processing module 114 checks whether the other program (i.e. the aforementioned “another program” in Step 935, such as the next program mentioned above) should take its turn to be watched/recorded at once, and more particularly, checks whether it is the time for the other program to be watched/recorded. When it is detected that the other program should take its turn to be watched/recorded at once, Step 934-2 is re-entered, with the other program (e.g. the next program) playing the role of the program mentioned in Step 934-2; otherwise, Step 950 is re-entered.

Some implementation details regarding the operations that may be performed when Step 934-2 is re-entered are described as follows. According to this embodiment, in a situation where the program viewing plan 112P indicates that the other program (i.e. the aforementioned “another program” in Step 935, such as the next program mentioned above) is broadcasted on the same channel such as the specific channel CH(0), when it is detected that the other program of the same channel (i.e. the specific channel CH(0) in this situation) should take its turn to be watched/recorded, the processing module 114 controls the multichannel broadcasting program receiver to stay in the specific channel CH(0), allowing the other program to be watched/recorded. On the contrary, in a situation where the program viewing plan 112P indicates that the other program (i.e. the aforementioned “another program” in Step 935, such as the next program mentioned above) is broadcasted on another channel CH(1), when it is detected that the other program of the other channel CH(1) (i.e. the aforementioned “another channel”) should take its turn to be watched/recorded, the processing module 114 triggers the multichannel broadcasting program receiver to switch to the other channel CH(1), and more particularly, controls the tuner 120 to switch to the channel CH(1), allowing the other program to be watched/recorded.

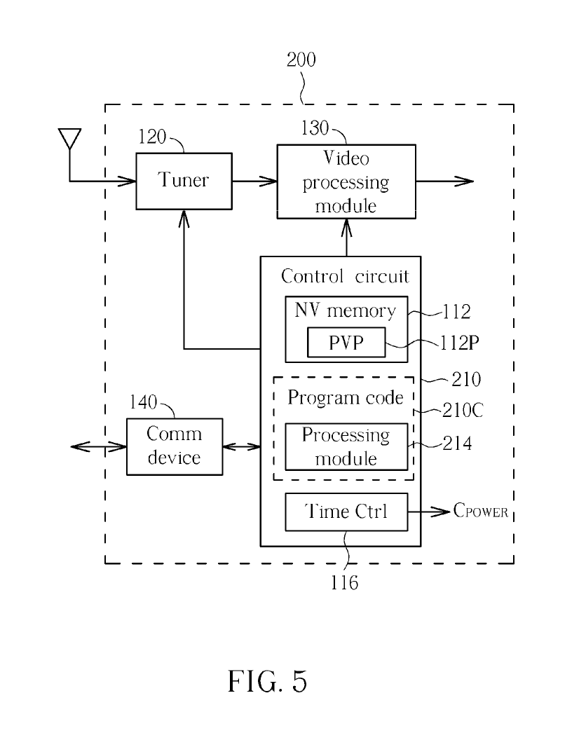

FIG. 5 is a diagram of an apparatus 200 for performing schedule control (e.g. schedule control regarding power on/off and/or channel switching) of a multichannel broadcasting program receiver according to a second embodiment of the present invention. According to this embodiment, at least a portion of the control circuit mentioned above can be implemented by utilizing a processor executing a program code 210C, and therefore, the control circuit mentioned above can be labeled with another numeral 210 in response to the change in architecture, where the apparatus mentioned above can be labeled with the numeral 200 in response to the change in architecture. In addition, the program code 210C may comprise at least one program module, such as a processing module 214, where the control circuit 210 executing the processing module 214 (and more particularly, the processor executing the processing module 214) can perform operations that are the same as or similar to those of the processing module 114. Similar descriptions are not repeated for this embodiment.

It is an advantage of the present invention that the present invention method and apparatus can save power by preventing unnecessary power consumption. In addition, based upon the program viewing plan 112P, the present invention method and apparatus can automatically control the schedule of watching/recording programs for the user, and the user may watch (or record) programs on schedule, having no need to spend a lot of time on scheduling. Additionally, in a situation where the user is touring/living without being accompanied by his/her family or close friends, the program viewing plan 112P can be determined based on the viewing plan information of a source viewing plan recommended by another user such as a family member or a close friend, and they may experience the pleasure of viewing the same program at the same time as if they were in the same living room.

Those skilled in the art will readily observe that numerous modifications and alterations of the device and method may be made while retaining the teachings of the invention.

1. A method for performing schedule control of a multichannel broadcasting program receiver, the method comprising:
retrieving viewing plan information from outside the multichannel broadcasting program receiver, for use of determining a program viewing plan for a user, wherein the viewing plan information indicates at least one source viewing plan recommended by at least one other user/service provider; and
when it is detected that a current time matches a start time of a specific program indicated by the program viewing plan, triggering the multichannel broadcasting program receiver to turn on a main power of the multichannel broadcasting program receiver, allowing the specific program to be watched/recorded.

2. The method of claim 1, wherein the step of retrieving the viewing plan information from outside the multichannel broadcasting program receiver further comprises:
retrieving the viewing plan information from outside the multichannel broadcasting program receiver by utilizing at least one communication device.

3. The method of claim 2, wherein the at least one communication device comprises a wireless communication device.

4. The method of claim 2, wherein the at least one communication device comprises an optical communication device.

5. The method of claim 1, wherein the step of retrieving the viewing plan information from outside the multichannel broadcasting program receiver further comprises:
retrieving the viewing plan information from outside the multichannel broadcasting program receiver through Internet.

6. The method of claim 1, wherein the step of triggering the multichannel broadcasting program receiver to turn on the main power of the multichannel broadcasting program receiver further comprises:
when it is detected that the current time matches the start time of the specific program indicated by the program viewing plan, sending at least one signal to trigger at least one display/recording device to be turned on, allowing the specific program to be watched/recorded.

7. The method of claim 6, wherein the at least one display/recording device is outside the multichannel broadcasting program receiver; and the at least one signal comprises at least one remote control signal.

8. The method of claim 6, wherein the at least one display/recording device is outside the multichannel broadcasting program receiver; and the at least one signal comprises at least one video signal.

9. The method of claim 1, wherein the step of triggering the multichannel broadcasting program receiver to turn on the main power of the multichannel broadcasting program receiver further comprises:
when it is detected that the current time matches the start time of the specific program indicated by the program viewing plan, triggering the multichannel broadcasting program receiver to turn on the main power and switch to a specific channel corresponding to the specific program, allowing the specific program to be watched/recorded, wherein the program viewing plan indicates that the specific program is broadcasted on the specific channel.

10. The method of claim 9, further comprising:
when it is detected that another program of the specific channel should take its turn to be watched/recorded, controlling the multichannel broadcasting program receiver to stay in the specific channel, allowing the other program to be watched/recorded, wherein the program viewing plan indicates that the other program is broadcasted on the specific channel.

11. The method of claim 9, further comprising:
when it is detected that another program of another channel should take its turn to be watched/recorded, triggering the multichannel broadcasting program receiver to switch to the other channel, allowing the other program to be watched/recorded, wherein the program viewing plan indicates that the other program is broadcasted on the other channel.

12. The method of claim 1, further comprising:
when it is detected that the specific program comes to an end, triggering the multichannel broadcasting program receiver to turn off the main power.

13. The method of claim 12, further comprising:
determining whether the specific program comes to the end by detecting whether it is an end time of the specific program.

14. The method of claim 12, further comprising:
determining whether the specific program comes to the end by detecting whether a predetermined duration of the specific program is expired.

15. The method of claim 1, wherein the viewing plan information complies with a predetermined format corresponding to a set of rules for encoding documents in a machine-readable form.

16. The method of claim 15, wherein the predetermined format is an Extensible Markup Language (XML) format.

17. The method of claim 15, wherein the predetermined format is a Really Simple Syndication (RSS) format.

18. An apparatus for performing schedule control of a multichannel broadcasting program receiver, the apparatus comprising:
a control circuit arranged to control operations of the multichannel broadcasting program receiver, wherein the processing circuit comprises:
a processing module arranged to retrieve viewing plan information from outside the multichannel broadcasting program receiver, for use of determining a program viewing plan for a user, wherein the viewing plan information indicates at least one source viewing plan recommended by at least one other user/service provider; and
a time control module, wherein when it is detected that a current time matches a start time of a specific program indicated by the program viewing plan, the time control module triggers the multichannel broadcasting program receiver to turn on a main power of the multichannel broadcasting program receiver, allowing the specific program to be watched/recorded.

19. The apparatus of claim 18, wherein the apparatus comprises at least one portion of the multichannel broadcasting program receiver.

20. The apparatus of claim 18, wherein the multichannel broadcasting program receiver is one or a combination of a digital video recorder (DVR), a set top box (STB), a television (TV), and/or a TV receiver.
